(19) United States
(12) Patent Application Publication
(10) Pub. No.: US 2026/0089257 A1
(43) Pub. Date: Mar. 26, 2026

(54) Systems and Methods for Automated Call Acceptance of Facility-Originated Telephone Calls with Prerecorded Preambles

(71) Applicant: Eric Jon Juvet, Seattle, WA (US)

(72) Inventor: Eric Jon Juvet, Seattle, WA (US)

(21) Appl. No.: 19/337,190

(22) Filed: Sep. 23, 2025

Related U.S. Application Data
(60) Provisional application No. 63/698,314, filed on Sep. 24, 2024.

(51) Int. Cl. H04M 3/493; H04M 3/51; H04M 7/12

(52) U.S. Cl. CPC H04M 3/4935; H04M 3/5166; H04M 7/1295

(57) ABSTRACT

A system and method are disclosed for automatically connecting outbound facility-originated telephone calls, such as calls placed by detainees from correctional, detention, or other secured facilities. The system includes a receiving interactive voice response (IVR) server configured to accept incoming calls and a controller configured to process preamble audio associated with the calls. The controller streams the audio to a speech recognition service, obtains a transcription, and transmits the transcription to an artificial intelligence module that determines a dual-tone multi-frequency (DTMF) tone required to accept the call. The controller instructs the receiving IVR server to issue the identified DTMF tone, thereby completing the call connection without human intervention or reliance on preconfigured facility information. The system may communicate with external services using application programming interfaces, structured data formats such as JSON or XML, and telecommunication protocols such as direct inward dialing, public switched telephone network, or equivalent mechanisms.

### CROSS-REFERENCE TO RELATED APPLICATION(S)

This application claims the benefit of U.S. Provisional Application No. 63/698,314 filed Sep. 24, 2024, the entire disclosure of which is hereby incorporated by reference.

### BACKGROUND

Telephone communication systems used in facilities, such as correctional, detention, and other secured institutions, often require a recorded preamble before an outgoing call from a detainee or other individual is connected to a recipient. The preamble typically instructs the recipient to press or say a specific dual-tone multi-frequency (DTMF) input in order to accept the call. The required input varies across facilities. For example, one facility may require pressing “5,” while another may require pressing “1.”

Automated systems that attempt to receive facility-originated calls face difficulties because they cannot reliably anticipate which DTMF tone will connect the call. Existing approaches rely on databases of known facilities, human intervention, or predetermined timing intervals. These approaches are prone to error and may drop calls if the preamble changes, if the timing drifts, or if the facility is not already stored in a database.

Disclosed systems and methods can automatically interpret the preamble in real time and issue the appropriate DTMF tone to accept the call and connect an interactive voice response system (IVR) to a live conversation with the caller, without prior knowledge of facility-specific requirements and without human involvement.

### BRIEF DESCRIPTION

The disclosure relates to systems and methods for automatically connecting outbound facility-originated telephone calls. A facility may include, but is not limited to, correctional facilities, detention centers, juvenile facilities, immigration detention centers, military holding facilities, or other secured institutions. In some embodiments, a facility-originated call may be a restricted call placed by a detainee that requires an answering party to provide an input to accept the call. In other embodiments, a facility-originated call may include calls outside the corrections context that are preceded by prerecorded preambles requiring an action, such as a dual-tone multi-frequency (DTMF) tone, by the answering party.

The system is designed to interpret preambles delivered by correctional, detention, and other secured facility telephony systems and to respond with the correct DTMF tone in real time, thereby establishing a live connection without requiring human intervention and reducing dropped calls.

The system and methods eliminate the current challenges of manually pressing the correct button to accept calls, a process that varies across different facilities. By automating this step, the system can ensure that calls are answered and routed appropriately, providing consistent and prompt access to essential services.

### BRIEF DESCRIPTION OF THE DRAWING(S)

FIG. 1 is a system diagram illustrating an architecture for automatically connecting outbound correctional facility calls, including a facility IVR server, a receiving IVR server, a controller, a speech recognition service, and an artificial intelligence service.

### DETAILED DESCRIPTION

### Applications

The disclosed systems and methods may be applied in a variety of environments where outbound telephone calls are preceded by prerecorded preambles requiring a DTMF input for call acceptance. In one embodiment, the system is applied to correctional and detention facilities, where outbound detainee calls require the call recipient to press or speak a designated input before the call is connected. In another embodiment, the system may be applied to other secured institutions, including immigration detention centers, juvenile facilities, or military holding facilities. In this context, this automation is valuable for offering a range of IVR services, such as automated delivery of legal help, assistance with re-entry planning, connecting detainees to support networks, and offering mental health resources. Moreover, it enhances communication efficiency, reduces missed connections, and allows for scalable, and more reliable and timely support to detainees.

The disclosed techniques may also be applied to environments where automated call acceptance is required outside correctional and detention facilities, such as secure conferencing systems, enterprise call centers, or other communication platforms requiring DTMF-based acceptance.

### Definitions

As used herein, certain terms are defined to clarify their meaning in the context of this disclosure. These definitions are illustrative and non-limiting.
“Artificial intelligence module” may refer to any natural language processing (NLP) system, statistical model, or neural network configured to interpret transcribed text and determine an output, such as a required DTMF tone. Examples include large language models, smaller domain-specific models, or hybrid systems.
“Controller” may refer to one or more processors, servers, virtual machines, cloud functions, or other computing resources configured to perform operations such as audio streaming, transcription, and call control as described herein. A controller may execute software instructions locally or in a distributed environment.
“DTMF tone” may refer to any dual-tone multi-frequency signaling digit or equivalent signal issued by a telephony system to interact with an IVR system or accept a call.
“Facility” may refer to a correctional facility, detention facility, immigration detention center, juvenile facility, military holding facility, or other secured institution from which outbound calls are originated. A facility may also include environments outside corrections where calls are preceded by prerecorded preambles requiring acceptance input, such as secure conferencing systems or enterprise call platforms.
“Facility-originated call” may refer to any outbound call initiated from a facility, including but not limited to correctional, detention, or secured institutions. In some embodiments, facility-originated calls may be restricted calls placed by detainees that are preceded by prerecorded preambles requiring a DTMF input or equivalent action by the answering party. In other embodiments, facility-originated calls may include calls from environments outside corrections that are preceded by prerecorded preambles requiring a DTMF input or equivalent action by the answering party.
“Heuristic classifier” may refer to any algorithm, rule-based system, or statistical model configured to distinguish between prerecorded preamble audio and live human speech.
“Interactive Voice Response (IVR) server” may refer to any hardware or software system capable of receiving incoming telephone calls, transmitting audio prompts, processing user input, and issuing DTMF tones. An IVR server may be implemented using commercial telephony platforms, cloud-based APIs, or custom-built telephony systems.
“Preamble” may refer to any automated audio message preceding a restricted call originating from a correctional, detention, or other secured facility, including but not limited to prompts requiring the call recipient to accept the call by pressing or saying a designated input.
“Speech recognition module” may refer to any system, service, or algorithm capable of converting audio into text, including cloud-based speech-to-text services, open-source speech recognition engines, or locally deployed models.

### Technology Context

In some embodiments, the disclosed system and methods may interact with external services and networks using standard telecommunication and software interfaces. For example, the controller may communicate with cloud-based or on-premise services through application programming interfaces (APIs), including but not limited to REST, gRPC, or equivalent protocols. Data may be exchanged in structured formats such as JavaScript Object Notation (JSON), XML, or other machine-readable encodings. Call routing may be implemented using direct inward dialing (DID) numbers, public switched telephone network (PSTN) connections, or session initiation protocol (SIP) trunks. The system may further employ webhooks or equivalent callback mechanisms to trigger operations in response to incoming calls, transcription events, or artificial intelligence outputs. These technologies are provided as illustrative examples, and the disclosed system is not limited to a particular vendor, protocol, or data format.

### System Overview

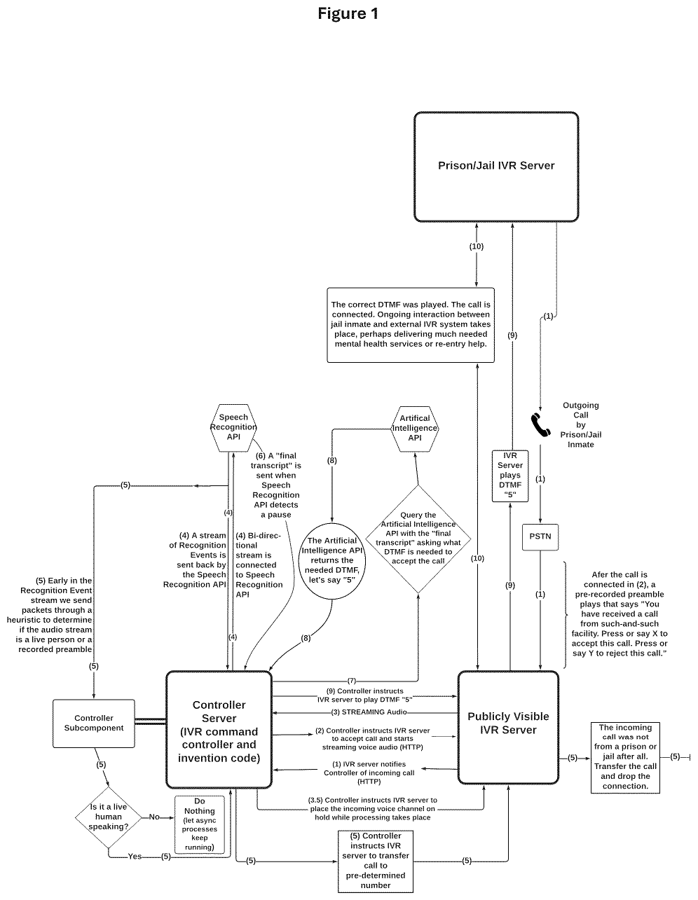

A system may comprise a receiving IVR server and a controller. The receiving IVR server accepts facility-originated calls. The controller communicates with the IVR server and is configured to:
1. receive an audio stream containing the preamble issued by the facility's telephony system, as shown in FIG. 1 paths (1), (2) and (3);
2. transmit the stream to a speech recognition module, which generates a transcription of the preamble, as shown in FIG. 1 paths (4), (5), (6);
3. forward the transcription to an artificial intelligence module, such as a neural language model, which interprets the text to determine the DTMF tone required to accept the call, as shown in FIG. 1 paths (7) and (8); and
4. instruct the IVR server to issue the identified DTMF tone, as shown in FIG. 1 paths (9) and (10).

The controller may employ a heuristic classifier to distinguish between prerecorded preambles and live human speech. In instances where live human speech is detected, the system may terminate transcription and bypass DTMF issuance. In instances where prerecorded preambles are detected, the system issues the DTMF tone, optionally during a pause in the preamble.

The system operates without reliance on pre-configured databases of facility identifiers, allowing it to accept calls from previously unknown facilities on the first attempt.

### Method

A method for connecting facility-originated calls from a facility may comprise:
receiving, at a receiving IVR server, a facility-originated call initiated by a detainee or other individual from a facility;
streaming audio of the facility's preamble to a controller;
processing the audio with a speech recognition module to generate a transcription;
analyzing the transcription with an artificial intelligence model to identify the required DTMF tone;
instructing the receiving IVR server to issue the DTMF tone; and
connecting the call to a destination endpoint without requiring prior configuration of the facility.

The method may further comprise distinguishing between prerecorded preamble audio and live human speech prior to analysis. The analyzing step may include transmitting the transcription to a neural network trained to interpret correctional facility call preambles. The instructing step may comprise sending a command via an application programming interface (API) to the receiving IVR server. Calls may be placed on hold while the transcription and analysis are performed and then connected upon issuance of the DTMF tone.

### Example Implementation

In one non-limiting embodiment, the disclosed system may be implemented using a combination of telephony servers, cloud services, and software modules. The following description provides an illustrative configuration that enables a person skilled in the art to construct and operate a working version of the system. This example is not intended to limit the scope of the claimed subject matter.

### Machines and Servers

Initiating IVR Server: An IVR server located on-premise or in a cloud environment associated with a correctional facility, configured to originate outbound calls placed by detainees.
Receiving IVR Server: A destination IVR server, implemented using a programmable telephony platform such as Twilio Voice XML or equivalent, configured to receive the inbound calls.
Controller Server: A separate server executing the core logic for handling audio streaming, speech recognition, and call control. The controller may be implemented using Node.js or an equivalent runtime environment.

### Services

Speech Recognition Service: A cloud-based speech-to-text service, such as Google Speech-to-Text API v2 or Deepgram, configured to convert streaming audio into text in real time.
Artificial Intelligence Service: A large language model accessible via an API, such as the OpenAI ChatGPT API, configured to interpret the transcribed preamble and identify the required DTMF tone.
Telephony Service: A programmable voice API such as Twilio Programmable Voice, configured to receive and manage incoming and outgoing calls, enqueue calls, and issue DTMF tones under controller instruction.

### Software Modules

In one embodiment, the controller server may execute several software modules:
acceptCall.js: A primary module responsible for receiving incoming calls, initiating audio streaming to the speech recognition service, processing transcribed results, forwarding text to the AI service, receiving the DTMF response, and instructing the receiving IVR server to issue the tone.
helpers.js: A set of auxiliary functions, including routines to query the AI service, classify early speech recognition results to distinguish preamble audio from live human speech, and generate synthesized speech output.
silent. xml: A static VoiceXML file configured to play silent or placeholder audio (such as a silent .mp3 file) while calls are temporarily placed on hold during transcription and analysis.
play.js: A test module configured to simulate an incoming correctional facility call by playing a pre-recorded preamble audio file into the system, thereby allowing demonstration and verification of functionality.

### Configuration and Deployment

In one example implementation, the modules may be deployed on a controller server running Node.js, with routes configured using an NGINX web server. Webhooks may be established between the telephony service and the controller to trigger execution of the modules.

Environment variables and API credentials (for example, OpenAI API keys, Twilio account SID and authentication tokens, and Google Speech-to-Text service account credentials) may be stored in secure configuration files and referenced by the modules during execution.

Two telephone numbers may be provisioned through the telephony service:
A destination number associated with the acceptCall.js module, configured with a webhook to process incoming calls.
A source number used by the play.js module to simulate outgoing calls for testing.

### Operation of the Example

During operation, a detainee places a call through the correctional facility IVR server. The receiving IVR server accepts the call and streams audio of the preamble to the controller server. The controller forwards the audio to the speech recognition service, which returns a transcription. The transcription is forwarded to the AI service, which interprets the instructions and returns the appropriate DTMF digit. The controller instructs the receiving IVR server to issue the DTMF tone, and the call is connected.

In testing scenarios, the play.js module may be executed to dial the receiving IVR server and play a stored audio file containing a facility preamble. This allows verification of the call-acceptance process without requiring a live correctional facility call.

### Alternative Embodiments

The disclosed systems and methods may be implemented in a variety of configurations beyond the example implementation described above. The following embodiments are illustrative and non-limiting:

### Alternative Programming Environments

While the example implementation describes modules written in Node.js, the controller server may alternatively be implemented in other programming languages or frameworks, including but not limited to Python (e.g., Flask or FastAPI), Java, C #, Go, or Rust.

### Alternative Telephony Platforms

The receiving IVR server may be implemented using telephony platforms other than Twilio, including Amazon Connect, Plivo, SignalWire, or custom SIP-based systems. Equivalent platforms providing programmable APIs for inbound call handling and DTMF signaling may be substituted.

### Alternative Speech Recognition Services

Speech recognition may be performed using services other than Google Speech-to-Text or Deepgram, including Amazon Transcribe, Microsoft Azure Speech, IBM Watson Speech-to-Text, or open-source speech recognition engines such as Vosk or Kaldi.

### Alternative Artificial Intelligence Models

The transcription analysis may be performed using natural language models other than OpenAI's ChatGPT API. Examples include Anthropic Claude, Cohere Command, Mistral, or open-source transformer-based models such as LLaMA or Falcon. In some embodiments, smaller domain-specific models trained exclusively on correctional facility preambles may be deployed locally.

### Alternative Architectures

In some embodiments, the system may operate entirely on-premise within a facility data center, without reliance on cloud services. In other embodiments, the system may be deployed in a hybrid cloud model, with speech recognition performed locally while transcription analysis is performed by a remote AI service.

### Alternative Preamble Handling

The system may employ statistical classifiers, finite state machines, or custom machine learning models to detect preambles, rather than heuristics based solely on speech recognition output. Similarly, silence-detection modules, energy-level analysis, or time-window segmentation may be used to identify appropriate points for DTMF tone issuance.

### Alternative Use Cases

Although primarily described in the context of correctional, detention, and other secured facility call acceptance, the system may be applied to other environments where prerecorded preambles precede user interaction. Examples include secure conferencing systems, enterprise call centers, customer service hotlines, emergency alert notification lines, or other communication platforms requiring DTMF-based acceptance.

What is claimed is:

1. A system for automatically connecting a facility-originated call from a facility, the system comprising:
a receiving interactive voice response (IVR) server configured to receive an incoming facility-originated call; and
a controller in communication with the receiving IVR server, the controller configured to:
receive, from the receiving IVR server, a streamed audio signal comprising a preamble associated with the incoming facility-originated call;
transmit the streamed audio signal to a speech recognition module;
obtain, from the speech recognition module, a transcription of the preamble;
transmit the transcription to an artificial intelligence module configured to identify a dual-tone multi-frequency (DTMF) tone required to accept the incoming facility-originated call; and
instruct the receiving IVR server to issue the identified DTMF tone, wherein the incoming facility-originated call is thereby connected to a destination endpoint without human intervention.

2. The system of claim 1, wherein the speech recognition module comprises a cloud-based speech-to-text service.

3. The system of claim 1, wherein the artificial intelligence module comprises a neural language model.

4. The system of claim 1, further comprising a heuristic classifier configured to distinguish between prerecorded preamble audio and live human speech.

5. The system of claim 1, wherein the controller terminates speech recognition upon detecting live human speech.

6. The system of claim 1, wherein the controller instructs the receiving IVR server to issue the DTMF tone during a pause in the preamble.

7. The system of claim 1, wherein the controller operates without reliance on a database of facility identifiers.

8. The system of claim 1, wherein the incoming facility-originated call is connected on a first attempt from a previously unknown facility.

9. A method for connecting an outbound facility-originated telephone call, the method comprising:
receiving, at a receiving IVR server, a facility-originated call;
streaming, from the receiving IVR server to a controller, audio of a preamble associated with the facility-originated call;
processing, by a speech recognition module, the audio to generate a transcription;
analyzing, by an artificial intelligence model, the transcription to determine a DTMF tone required to accept the facility-originated call;
instructing, by the controller, the receiving IVR server to issue the DTMF tone; and
connecting the facility-originated call to a destination endpoint without requiring pre-configured facility information.

10. The method of claim 9, further comprising distinguishing between prerecorded preamble audio and live human speech prior to analyzing the transcription.

11. The method of claim 9, wherein the analyzing comprises transmitting the transcription to a neural network model trained to interpret telephone call preambles.

12. The method of claim 9, wherein instructing the receiving IVR server to issue the DTMF tone comprises sending a command from the controller to the receiving IVR server via an application programming interface.

13. The method of claim 9, further comprising placing the facility-originated call on hold until the DTMF tone is issued.

14. The method of claim 9, wherein the facility-originated call is connected on a first attempt from a previously unknown facility.

15. A system for automated call acceptance, the system comprising:
an initiating IVR server located at a facility;
a receiving IVR server implemented using a programmable telephony platform; and
a controller server comprising executable code stored on a non-transitory computer-readable medium, the executable code configured to:
stream incoming audio from the receiving IVR server to a cloud-based speech-to-text service;
distinguish, based on transcribed output, between prerecorded preamble audio and live human speech;
upon detecting a preamble, forward a transcription to a natural language processing model;
receive, from the natural language processing model, an output identifying a DTMF tone; and
instruct the receiving IVR server, via an application programming interface, to issue the DTMF tone, wherein a call is connected regardless of variations in preamble content or timing.

16. The system of claim 15, wherein the programmable telephony platform comprises a telephony system providing a voice markup language or equivalent programmable call-control interface.

17. The system of claim 15, wherein the cloud-based speech-to-text service comprises a speech recognition engine configured to perform real-time transcription of streaming audio.

18. The system of claim 15, wherein the natural language processing model comprises a generative language model.

19. The system of claim 15, wherein the controller server is implemented using a programming language or runtime environment configured to execute asynchronous tasks.

20. The system of claim 15, wherein the executable code comprises modules configured to manage call acceptance, provide auxiliary processing functions, and simulate facility-originated calls for testing.
